(19) United States
(12) Patent Application Publication
(10) Pub. No.: US 2023/0222397 A1
(43) Pub. Date: Jul. 13, 2023

(54) METHOD FOR AUTOMATED ENSEMBLE MACHINE LEARNING USING HYPERPARAMETER OPTIMIZATION

(71) Applicant: SAUDI ARABIAN OIL COMPANY, Dhahran (SA)

(72) Inventors: Balaji Mohan, Dhahran (SA); Jihad Badra, Dhahran (SA)

(73) Assignee: SAUDI ARABIAN OIL COMPANY, Dhahran (SA)

(21) Appl. No.: 17/647,375

(22) Filed: Jan. 7, 2022

(51) Int. Cl. G06N 20/20; G06N 3/12; E21B 41/00

(52) U.S. Cl. CPC G06N 20/20; G06N 3/126; E21B 41/00; E21B 2200/20; E21B 47/00

(57) ABSTRACT

A method for a hyperparameter optimization for an automated ensemble machine learning model includes: generating an initial population of a plurality of machine learning (ML) models with a plurality of randomly chosen hyperparameters; calculating a loss function for each of the plurality of machine learning models; creating a new population of ML models and generating a base learner model using the hyperparameters of the best model. The method for creating the new population include the steps of: (a) selecting multiple best models with least errors as parents from a previous generation; (b) creating an offspring of the new population of ML models with a crossover probability and a mutation probability; and (c) repeating the steps (a) and (b) until a number of generations is reached and reporting the hyperparameters of the best model.

### BACKGROUND

Machine learning (ML) applications have seen tremendous growth in recent years. With the current migration of industries towards industrial revolution 4.0, the ML models find increased real-world applications. Unfortunately, the practical applications of ML models require expert knowledge of the models and the problem domain. It is challenging to find scientists knowledgeable in both domain and ML models. Thus, harnessing the ML models' full potential to a specific problem is often a costly endeavor in both time and computation. Therefore, the substantial progress in ML has also led to a demand for automated ML (AutoML) models that can assist the users and deskill the process to make it efficient to be used by everyone.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for a hyperparameter optimization for an automated ensemble machine learning model includes: generating an initial population of a plurality of machine learning (ML) models with a plurality of randomly chosen hyperparameters; calculating a loss function for each of the plurality of machine learning models; creating a new population of ML models and generating a base learner model using the hyperparameters of the best model. The method for creating the new population includes the steps of: (a) selecting multiple best models with least errors as parents from a previous generation; (b) creating an offspring of the new population of ML models with a crossover probability and a mutation probability; and (c) repeating the steps (a) and (b) until a number of generations is reached and reporting the hyperparameters of the best model.

In another aspect, embodiments disclosed herein generally relate to a method for an automated ensemble machine learning model that includes: obtaining a raw dataset and performing feature engineering to extract features and targets to obtain a processed dataset using a domain knowledge; dividing the processed dataset into training, test, and validation datasets; training a plurality of default or optimized base learner models, using the training datasets to produce a plurality of trained base learner models; calculating predictions of the plurality of the trained base learner models using the test datasets; calculating an optimal weighted model from the plurality of trained base learner models to build a trained automated ensemble machine learning (ML) model using a constrained-based optimization algorithm based on a prediction accuracy of an automated ensemble ML model, if the trained base learner models are not tuned using a hyperparameter optimization; and validating the trained automated ensemble ML model using the validation datasets, previously set aside exclusively for validation purposes. The method for the hyper parameter optimization includes the steps of: generating an initial population of a plurality of machine learning (ML) models with a plurality of randomly chosen hyperparameters; calculating a loss function for each of the plurality of machine learning models; creating a new population of ML models and generating a base learner model using the hyperparameters of the best model. The method for creating the new population includes the steps of: (a) selecting multiple best models with least errors as parents from a previous generation; (b) creating an offspring of the new population of ML models with a crossover probability and a mutation probability; and (c) repeating the steps (a) and (b) until a number of generations is reached and reporting the hyperparameters of the best model.

In another aspect, embodiments disclosed herein generally relate to a non-transitory computer readable medium storing instruction. The instructions are executable by a computer processor and include functionality for: generating an initial population of a plurality of machine learning (ML) models with a plurality of randomly chosen hyperparameters; calculating a loss function for each of the plurality of machine learning models; creating a new population of ML models and generating a base learner model using the hyperparameters of the best model. The instructions for creating the new population include the steps of: (a) selecting multiple best models with least errors as parents from a previous generation; (b) creating an offspring of the new population of ML models with a crossover probability and a mutation probability; and (c) repeating the steps (a) and (b) until a number of generations is reached and reporting the hyperparameters of the best model.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows an exemplary system diagram in accordance with one or more embodiments.

FIG. 2 shows an exemplary schematic in accordance with one or more embodiments.

FIGS. 3A and 3B show flowcharts in accordance with one or more embodiments.

FIGS. 4A and 4B show plots in accordance with one or more embodiments.

FIG. 4C shows a table in accordance with one or more embodiments.

FIGS. 5A and 5B show a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

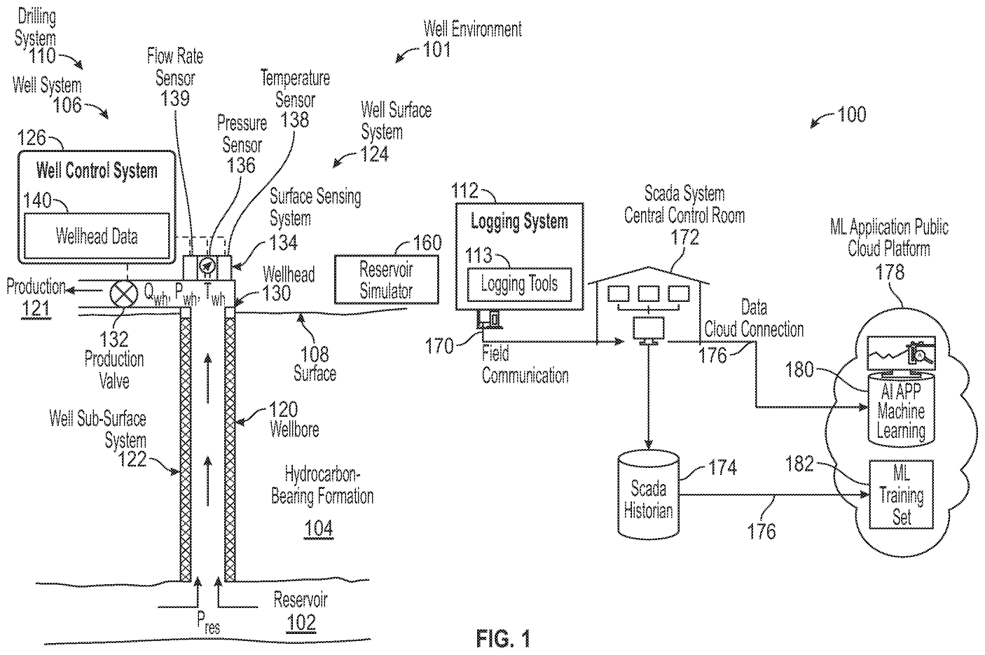

In the following description of FIGS. 1-5, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

Although multiply dependent claims are not introduced, it would be apparent to one of ordinary skill that the subject matter of the dependent claims of one or more embodiments may be combined with other dependent claims.

In general, embodiments disclosed herein provides framework for a genetic algorithm-based hyperparameter tuning automated ensemble ML algorithm that may be used to address the challenge of lack of skilled data scientists and assist domain scientists and engineers in deploying ML to their applications. In particular, ML has the potential for changing the game in the oil and gas industry, including in the areas of automation, data collection and assessment, algorithms, analytics in a consumable format, predictions/recommendations, maximized efficiencies and automated adjustments. Routine tasks in the oil and gas industry often require analyzing complex data sets so that the work is with maximum efficiency and return on investment. These applications come to life in different ways across the oil and gas value chain, as described below.

Upstream services: ML provides assistance with both locating the most efficient place to start a well and improving how a company extracts oil and gas. Such improvements include predictive analysis, accurate modeling, exploration, dig sites, well logging, oilfield operations, drilling efficiencies, rig optimization, risk detection, remote operations and completion. ML streamlines these replicable processes because the computer system can analyze large collections of data points faster and more efficiently than a human.

Midstream services: involves transporting the product from the field to the refinery. ML may aid with gathering the product(s), transportation, logistics and pipeline usage/distribution/load, etc. Because an algorithm can crunch numbers so quickly, it can provide specific recommendations for improving the efficiency of a delivery systems.

Downstream services: many of the same applications of ML in upstream and midstream processes are relevant for downstream production services. For example, processing, refining, remote systems operation and risk analysis. It is not possible to have enough human employees to observe, analyze, and report each moving part of the refinery; thus, ML can absorb that information to make informed decisions to help people.

Back-office management: ML helps in improving the office environment by helping in saving money with proactive decision-making. As systems are observing so many working elements of operations, they can use the data being collected to make specific recommendations that impact a business. For example, with respect to maintenance of wells, performance of equipment (wells), services and equipment, market analysis, forecasting, retail sales, and marketing the product. Thus, ML provides the perfect technology for automating tasks that require parsing large collections of data and making predictions with both speed and accuracy.

In particular, one or more embodiments of the invention are directed to a genetic algorithm (GA) based approach developed to automate the optimization of the individual hyperparameters models in the ML model. This framework is referred to as an automated ensemble ML model. The GA approach has been compared with an automated Bayesian optimization (BO)-based model with the same individual ML models and further with an automated TPOT (Python Automated ML tool) model, which uses similar genetic programming at the backend. In addition, a plurality of different benchmark datasets with varying input features and data records have been used to benchmark all the developed automated ML models. The automated ensemble ML model developed has been evaluated in terms of prediction accuracy and computational times.

FIG. 1 shows a schematic diagram in accordance with one or more embodiments. FIG. 1 illustrates a system for a ML to assist in a well environment (100) that may include a well environment (101), a field communication (170), a supervisory control and data acquisition (SCADA) system (172), and a ML application public cloud platform (178).

FIG. 1 illustrates a well environment (101) in which a monitoring system to monitor operating parameters of rig equipment may be implemented, includes a hydrocarbon reservoir (“reservoir”) (102) located in a subsurface hydrocarbon-bearing formation (“formation”) (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102).

The well environment (101) may include a drilling system (110) and a logging system (112). The drilling system (110) may include a drill string, drill bit or a mud circulation system for use in boring the wellbore (120) into the hydrocarbon-bearing formation (104).

The logging system (112) may include one or more logging tools (113), such as a nuclear magnetic resonance (NMR) logging tool or a resistivity logging tool, for use in generating wellhead data (140) of the formation (104). For example, a logging tool may be lowered into the wellbore (120) to acquire measurements as the tool traverses a depth interval (for example, targeted reservoir section) of the wellbore (120). The plot of the logging measurements versus depth may be referred to as a “log” or “well log”. Well logs may provide depth measurements of the well system (106) that describe such reservoir characteristics as formation porosity, formation permeability, resistivity, water saturation, and the like. The resulting logging measurements may be stored or processed or both, for example, by the well control system (126), to generate corresponding well logs for the well system (106). A well log may include, for example, a plot of a logging response time versus true vertical depth (TVD) across the depth interval of the wellbore (120).

In some embodiments, the well system (106) includes a wellbore (120), a well sub-surface system (122), a well surface system (124), and a well control system (“control system”) (126).

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

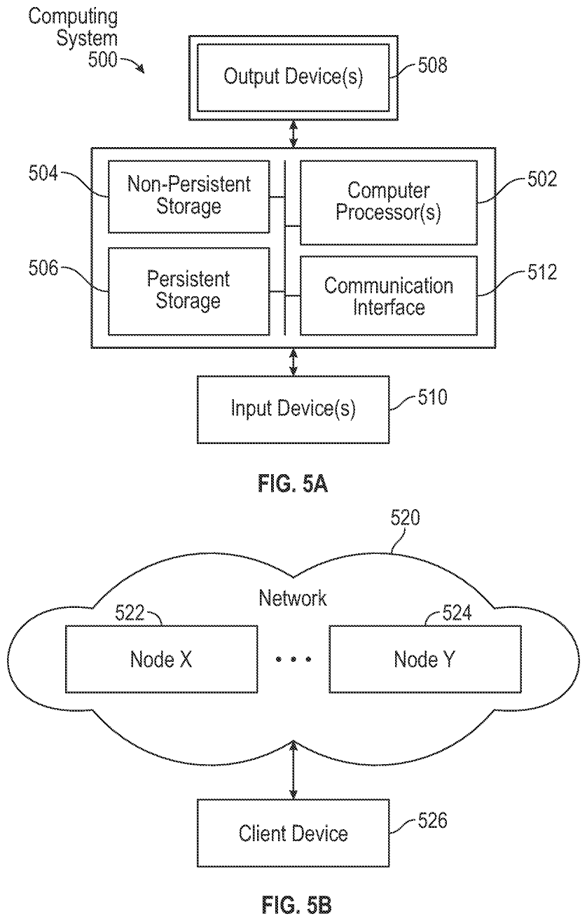

In some embodiments, the control system (126) may control various operations of the well system (106), such as well production operations, well completion operations, well maintenance operations, and reservoir monitoring, assessment, and development operations. The control system (126) may include hardware or software for managing drilling operations or maintenance operations. For example, the control system (126) may include one or more programmable logic controllers (PLCs) that include hardware or software with functionality to control one or more processes performed by the drilling system (110). Specifically, a programmable logic controller may control valve states, fluid levels, pipe pressures, warning alarms, or pressure releases throughout a drilling rig. In particular, a programmable logic controller may be a ruggedized computer system with functionality to withstand vibrations, extreme temperatures (for example, ˜575° C.), wet conditions, or dusty conditions, for example, around the rig (101). Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress. In some embodiments, the control system (126) includes a computer system that is the same as or similar to that of computer system (500) described below in FIGS. 5A and 5B and the accompanying description.

In some embodiments, sensors may be included in the well control system (126) that includes a processor, memory, and an analog-to-digital converter for processing sensor measurements. For example, the sensors may include acoustic sensors, such as accelerometers, measurement microphones, contact microphones, and hydrophones. Likewise, the sensors may include other types of sensors, such as transmitters and receivers to measure resistivity or gamma ray detectors. The sensors may include hardware or software or both for generating different types of well logs (such as acoustic logs or sonic longs) that may provide data about a wellbore on the formation, including porosity of wellbore sections, gas saturation, bed boundaries in a geologic formation, fractures in the wellbore or completion cement. If such well data is acquired during drilling operations (that is, logging-while-drilling), then the information may be used to adjust drilling operations in real-time. Such adjustments may include rate of penetration (ROP), drilling direction, and altering mud weight.

In some embodiments, the well sub-surface system (122) includes casing installed in the wellbore (120). For example, the wellbore (120) may have a cased portion and an uncased (or “open-hole”) portion. The well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing. In some embodiments, the well surface system (124) includes flow regulating devices that are operable to control the flow of substances into and out of the wellbore (120). For example, the well surface system (124) may include one or more production valves (132) that are operable to control the flow of production (121). For example, a production valve (132) may be fully opened to enable unrestricted flow of production (121) from the wellbore (120), the production valve (132) may be partially opened to partially restrict (or “throttle”) the flow of production (121) from the wellbore (120), and production valve (132) may be fully closed to fully restrict (or “block”) the flow of production (121) from the wellbore (120), and through the well surface system (124).

Keeping with FIG. 1, in some embodiments, the well surface system (124) includes a surface sensing system (134). The surface sensing system (134) may include sensors for sensing characteristics of substances, including production (121), passing through or otherwise located in the well surface system (124). The characteristics may include, for example, pressure, temperature, and flow rate of production (121) flowing through the wellhead (130), or other conduits of the well surface system (124), after exiting the wellbore (120).

In some embodiments, the surface sensing system (134) includes a surface pressure sensor (136) operable to sense the pressure of production (121) flowing through the well surface system (124), after it exits the wellbore (120). The surface pressure sensor (136) may include, for example, a wellhead pressure sensor that senses a pressure of production (121) flowing through or otherwise located in the wellhead (130). In some embodiments, the surface sensing system (134) includes a surface temperature sensor (138) operable to sense the temperature of production (121) flowing through the well surface system (124), after it exits the wellbore (120). The surface temperature sensor (138) may include, for example, a wellhead temperature sensor that senses a temperature of production (121) flowing through or otherwise located in the wellhead (130), referred to as “wellhead temperature” (T_{wh}). In some embodiments, the surface sensing system (134) includes a flow rate sensor (139) operable to sense the flow rate of production (121) flowing through the well surface system (124), after it exits the wellbore (120). The flow rate sensor (139) may include hardware that senses a flow rate of production (121) (Q_{wh}) passing through the wellhead (130).

In some embodiments, the measurements are recorded, and are available for review or use within seconds, minutes or hours of the condition being sensed (e.g., the measurements are available within 1 hour of the condition being sensed). In such an embodiment, the wellhead data (140) may enable an operator of the well system (106) to assess a relatively current state of the well system (106) and make decisions regarding development of the well system (106) and the reservoir (102), such as on-demand adjustments in regulation of production flow from the well.

In some embodiments, the well control system (126) through the logging system (112) collects and records wellhead data (140) for the well system (106).

In some embodiments, the well system (106) is provided with a reservoir simulator (160). For example, the reservoir simulator (160) may store well logs and data regarding core samples for performing simulations. The reservoir simulator (160) may further analyze the well log data, the core sample data, seismic data, and/or other types of data to generate and/or update the one or more reservoir models. While the reservoir simulator (160) is shown at a well site, embodiments are contemplated where reservoir simulators are located away from well sites. the reservoir simulator (160) may include hardware or software with functionality for generating one or more trained models regarding the formation (104). For example, the reservoir simulator (160) may store well logs and data regarding core samples, and further analyze the well log data, the core sample data, seismic data, or other types of data to generate or update the one or more trained models having a complex geological environment. For example, different types of models may be trained, such as machine learning, artificial intelligence, convolutional neural networks, deep neural networks, support vector machines, decision trees, inductive learning models, deductive learning models, and supervised learning models, and are capable of approximating solutions of complex non-linear problems. The reservoir simulator (160) may couple to the logging system (112) and the drilling system (110).

In some embodiments, the reservoir simulator (160) may include functionality for applying ML and deep learning methodologies to precisely determine various subsurface layers. To do so, a large amount of interpreted data may be used to train a model. To obtain this amount of data, the reservoir simulator (160) may augment acquired data for various geological scenarios and drilling situations. For example, drilling logs may provide similar log signatures for a particular subsurface layer except where a well encounters abnormal cases. Such abnormal cases may include, for example, changes in subsurface geological compositions, well placement of artificial materials, or various subsurface mechanical factors that may affect logging tools. As such, the amount of well data with abnormal cases available to the reservoir simulator (160) may be insufficient for training a model. Therefore, in some embodiments, the reservoir simulator (160) may use data augmentation to generate a dataset that combines original acquired data with augmented data based on geological and drilling factors. This supplemented dataset may provide sufficient training data to train a model accordingly.

In some embodiments, the reservoir simulator (160) is implemented in a software platform for the well control system (126). The software platform may obtain data acquired by the drilling system (110) and logging system (112) as inputs, which may include multiple data types from multiple sources. The software platform may aggregate the data from these systems (110, 112) for rapid analysis. In some embodiments, the well control system (140), the logging system (112), or the reservoir simulator (160) may include a computer system that is similar to the computer system (500) described with regard to FIGS. 5A and 5B and the accompanying description.

In some embodiments, the SCADA system (172) is a centralized system linked with the well control system (140), the logging system (112), or the reservoir simulator (160) through the field communication (170) and provides supervisory control of the well system (106). The SCADA system (172) feeds the process data to a high-speed SCADA historian database (174). The field communication (170) may be provided by a high-availability, high-speed, fiber-optic network.

A challenge with a ML-based monitoring application is that it requires a data training set, which needs significant time and effort to prepare. Nonetheless, once the ML model has learned the normal behavioral relations across all of the varied parameters of a system, such as the well environment (102), it can begin comparing massive amounts of system data to its baseline data set. ML starts working when a basic algorithm analyzes a large data set and then makes predictions based upon what it finds in the data. Using pattern recognition, ML models are capable of uncovering any anomalous relationships that emerge in a system's operation, and then analyzing those differences and provide the probabilities of future behavior. The algorithm applies that knowledge to learn new ways of analyzing and acting upon future data sets. In some embodiments, a ML-based monitoring application (180) with a ML training set (182) is deployed in the ML application public cloud platform (178) through a data cloud connection (176). The ML-based monitoring application (180) may be executed on any suitable computing device, such as that shown in FIGS. 5A-5B. Further, the ML training set (182) may come from operation of any of the components of the system shown in FIG. 1, for example, well-log data,

Ensemble ML Model

In one or more embodiments, an ensemble ML model is developed in the python programming language. The ensemble ML model is a super learner (SL) ensemble of different individual ML algorithms called base learner models. A meta learner is then used to find weighting factors of multiple base learner models that minimize the cross-validated error. The ensemble ML model may be developed using python packages, for example, Scikit-Learn, Scipy, and Numpy.

In some embodiments, the following ML algorithms are used as base learner models in the ensemble ML model:

Artificial Neural Networks (ANNs): ANNs are loosely modeled based on the biological nervous system. A multilayer perceptron with a backpropagation learning algorithm was used in this study with one input layer, three hidden layers, and one output layer. The input layer consists of a set of neurons representing the number of input features. Each neuron in the hidden layer transforms the previous layer's values with a weighted linear summation, followed by a nonlinear activation function. The output layer receives the values from the last hidden layer and transforms them into output values.

Support Vector Machine (SVM): SVM constructs a hyperplane in N-dimensional space, where N is the number of input features that can be used for classification or regression. The objective of SVM regression is to find a hyperplane that incurs minimum cost. Kernels are used to enable the learning of nonlinear functions.

Elastic Net Regularization (ENR): ENR is a generalized linear model that includes both L1 and L2 regularization of Lasso and Ridge methods. A regularization technique is a penalty mechanism that applies a decrease of the coefficient to build a more robust and economic model.

Kernel Ridge Regression (KRR): KRR combines the ridge regression with kernel mapping. The kernel can potentially be an infinite number of nonlinear transformations of the independent variables as regressors. KRR is identical to SVR except that different loss functions are used, and KRR is typically faster than SVR for medium-sized datasets.

LightGBM Regressor (LGB): LGB is a gradient boosting framework that used tree-based learning algorithms. It is histogram-based and places continuous values into discrete bins, which leads to faster training and more efficient memory usage. The framework uses a leaf-wise tree growth algorithm, unlike many other tree-based algorithms that use depth-wise growth. Leaf-wise tree growth algorithms tend to converge faster than depth-wise ones but tend to be more prone to overfitting. The LightGBM framework's advantages are faster training speed and higher efficiency, lower memory usage, better accuracy, support of parallel and GPU learning, capable of handling large-scale data.

CatBoost Regressor (CBR): CatBoost is an algorithm for gradient boosting on decision trees. CatBoost uses the implementation of ordered boosting, a permutation-driven alternative to the classic algorithm, and an innovative algorithm for processing categorical features. The CatBoost algorithm's advantages are high accuracy and faster predictions without parameter tuning, native support for categorical features, and quick and scalable GPU implementation.

In some embodiments, the ML algorithms then create an optimal weighted average of the n base learner models, called an ensemble, using a test data performance. The prediction Ψ_{ML} from the ensemble ML model, is given as

$${Ψ}_{ML} = {\sum }_{k = 1}^{n} {w}_{k} {ψ}_{K} , {w}_{k} \geq 0 \qquad ( 1 )$$

$$W = {\sum }_{k = 1}^{n} {w}_{k} = 1 \qquad ( 2 )$$

where, ψₖ and wₖ are predictions on test data and the weighting factor of the k^{th} base learner model. In one or more embodiments, the weighting factor (W) is optimized using a constrained-based optimization algorithm, for example, the Sequential Least-Squares Programming method (SLSQP) to include the equality constraint. The weighting factors wₖ can be a positive value or zero, denoting that prediction of the base learner model is excluded in the ensemble ML model to minimize the overall error. This approach has been proven to be asymptotically as accurate as the best possible prediction algorithm tested.

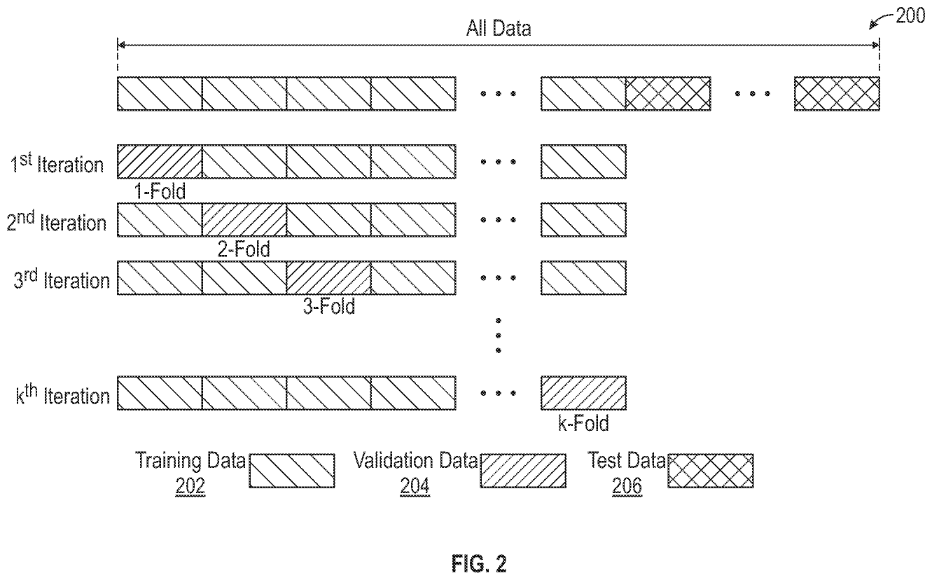

In some embodiments, the ensemble ML model implementation uses k-fold cross-validation (CV) to avoid overfitting of the model to the ⅘^{th} of the dataset used for training purposes. It also provides performance assessment of the models by comparing the prediction accuracy of the model on test data against the training data. FIG. 2 shows an example of k-fold validation process (200) used in accordance with one or more embodiments. Cross-validation is a statistical method used to estimate the skill of machine learning models. It is commonly used in applied machine learning to compare and select a model for a given predictive modeling problem because it is easy to understand, easy to implement, and results in skill estimates that generally have a lower bias than other methods. The procedure has a single parameter called k that refers to the number of groups that a given data sample is to be split into. When a specific value for k is chosen, it may be used in place of k in the reference to the model, such as k=10 becoming 10-fold cross-validation.

As shown in FIG. 2, validation process (200) uses training data (202), validation data (204) and test data (206). An iterative process is performed for each of the k groups of data by taking the k^{th} group as a validation (hold out) or test data set and the remaining groups as a training data set for each iteration. The final validation of the ensemble ML model is then performed on an unseen ⅕^{th} of the dataset exclusively set aside for test purposes. The test guarantees the prediction capability of the ensemble ML model on data outside the training dataset.

Automated Ensemble Machine Learning Model

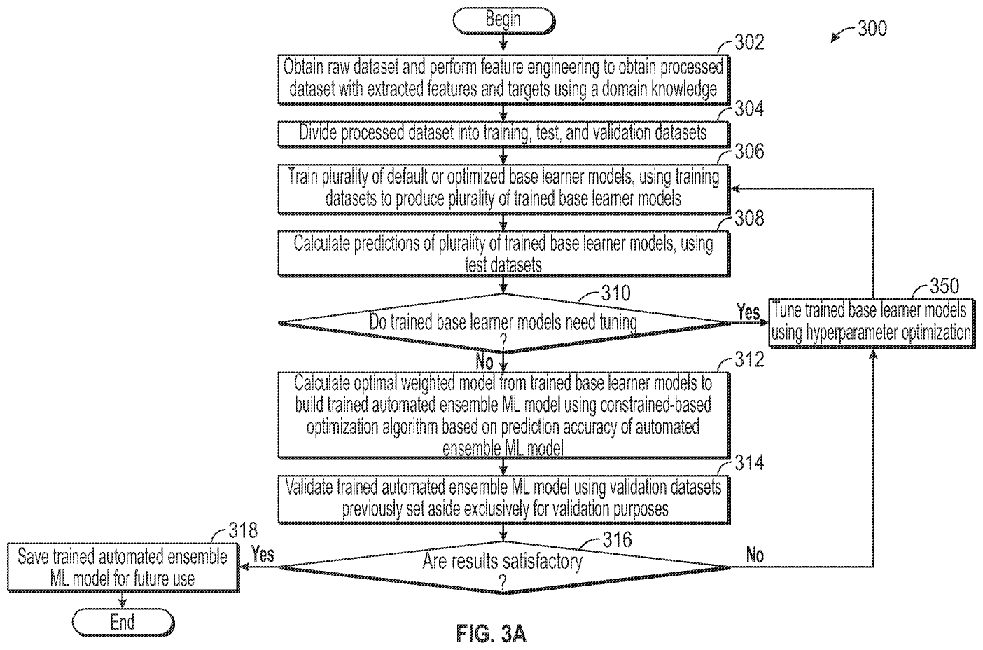

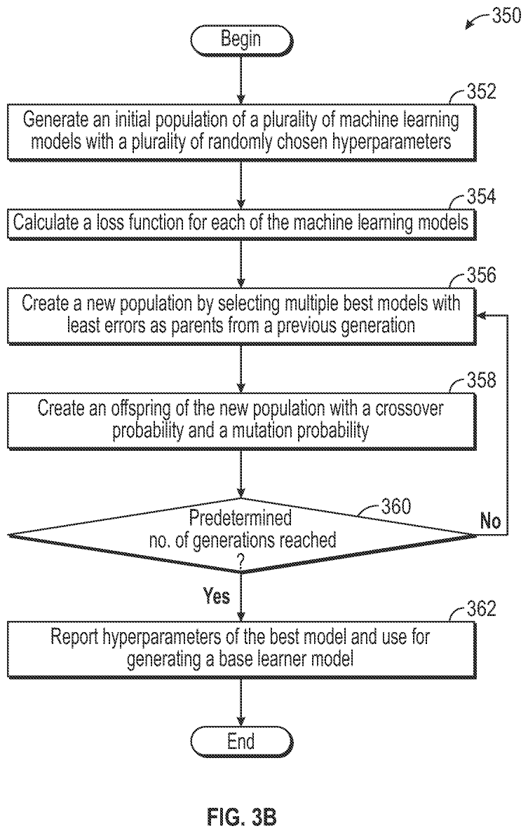

FIG. 3A shows a flowchart (300) in accordance with one or more embodiments. Specifically, FIG. 3A describes a general method of a GA-based automated ensemble ML model. While the various steps in FIG. 3A are presented and described sequentially, one of ordinary skill in the art will appreciate that some or all of the steps may be executed in different orders, may be combined or omitted, and some or all of the steps may be executed in parallel. Furthermore, the steps may be performed actively or passively. The method may be repeated or expanded to support multiple components and/or multiple users within a field environment. Accordingly, the scope of the invention should not be considered limited to the specific arrangement of steps shown in the flowchart.

In step 302, a raw dataset is obtained and a feature engineering is performed on the raw dataset to obtain a processed dataset with extracted features and targets using a domain knowledge in accordance with one or more embodiments. This involves applying a suite of common or commonly useful data preparation techniques to the raw dataset, then aggregating all features together to create one large dataset, then fit and evaluate a model on this data. The raw dataset may be any benchmark dataset with a plurality of feature inputs and targets. For example, raw datasets and feature inputs may be taken from the following benchmark datasets described below in paragraphs [0075]-[0082].

In step 304, the processed dataset (obtained after feature engineering is performed on the raw dataset) is divided into training, test, and validation datasets in accordance with one or more embodiments.

In step 306, a plurality of default or optimized base learner models are trained using the training datasets to produce a plurality of trained base learner models in accordance with one or more embodiments. For example, “n” default and/or optimized base learner models are trained using the training datasets to produce the “n” trained base learner models. However, at the first time, default parameters of the base learner models used are not previously optimized.

In step 308, predictions of the plurality of trained base learner models are calculated using the test datasets in accordance with one or more embodiments. For example, the predictions of “n” trained base learner models are calculated using the test datasets.

In step 310, a determination is made as to whether the trained base learner models need tuning in accordance with one or more embodiments. In step 350, if the trained base learner models need further tuning based on the prediction accuracy of the test results, the trained base learner models are subjected to further hyperparameter optimization in accordance with one or more embodiments.

In step 312, if no further hyperparameter optimization is required, a trained automated ensemble ML model is built by calculating an optimal weighted model from the trained base learner models using a constrained-based optimization algorithm based on a prediction accuracy of an automated ensemble ML model in accordance with one or more embodiments. For example, an ensemble ML model is built by calculating an optimal weighted model from the “n” trained base learner models using any constrained-based optimization algorithm, for example, SLSQP based on the definition of prediction accuracy (WML) of the automated ensemble ML model described above in paragraph [0053].

In step 314, the trained automated ensemble ML model is validated using the validation datasets previously set aside exclusively for validation purposes in accordance with one or more embodiments.

In step 316, a determination is made as to whether the results obtained are satisfactory in accordance with one or more embodiments. In step 318, if the results obtained are satisfactory, the trained automated ensemble ML model is saved for future use. If the results are not satisfactory, steps 306 to 316 are repeated and the hyperparameter optimization process is called again until an acceptable automated ensemble ML model is obtained.

Hyperparameter Optimization

FIG. 3B shows a flowchart (350) in accordance with one or more embodiments. Specifically, FIG. 3B describes a general method of a GA-based hyperparameter optimization used in the automated ensemble ML models, as shown in FIG. 3A. One or more steps in FIG. 3B may be performed by one or more components (for example, step 350) as described in FIG. 3A. While the various steps in FIG. 3B are presented and described sequentially, one of ordinary skill in the art will appreciate that some or all of the steps may be executed in different orders, may be combined or omitted, and some or all of the steps may be executed in parallel. Furthermore, the steps may be performed actively or passively. The method may be repeated or expanded to support multiple components and/or multiple users within a field environment. Accordingly, the scope of the invention should not be considered limited to the specific arrangement of steps shown in the flowchart.

In step 352, an initial population of a plurality of ML models is generated with a plurality of randomly generated hyperparameters in accordance with one or more embodiments. In one or more embodiments, since the objective function to map the hyperparameters to the ML model's performance is a BlackBox function, genetic algorithm may perform better than the other hyperparameter optimization algorithms.

In some embodiments, the developed GA-based hyperparameter optimization algorithm treats the hyperparameters into three main categories: continuous, categorical, and constant parameters. The continuous parameters are those hyperparameters whose values are continuous real or integer numbers; for example, the number of layers in the ANN model is a continuous parameter. Categorical parameters are used to treat those hyperparameters whose values are categorical; for example, the kernel hyperparameter in Support Vector Regression (SVR) is a categorical parameter that takes only the values shown in Table 1. SVR is a popularly and widely used for regression problems in ML. Constant parameters are used when the desired hyperparameter has values other than default values for the ML models and need to be kept constant.

In step 354, a loss function for each of the ML models is calculated in accordance with one or more embodiments. In some embodiments, the loss function is determined as the difference between an actual output and a predicted output from the model for a single training example while the average of the loss function for all the training example is termed as the cost function. This computed difference from the loss functions (such as Regression Loss, Binary Classification and Multiclass Classification loss function) is termed as the error value; this error value is directly proportional to the difference in the actual and the predicted value. If the deviation in the predicted output value than the predicted output value by the ML model is large, then the loss function gives the higher number as output, and if the deviation is small and much closer to the predicted output value, it outputs a smaller number.

TABLE 1

| Model | Hyperparameters | Minimum value | Maximum value |
|---|---|---|---|
| ANN | No. of neurons in hidden | 10 | 250 |
| | layers | | |
| | Alpha | 1e−6 | 1.0 |
| | Tol | 1e−6 | 1e−4 |
| | Max iterations | 200 | 2000 |
| SVM | C | 1e−6 | 100 |
| | Degree | 1 | 10 |
| | Kernel | poly, rbf, sigmoid | |
| ENR | Alpha | 1e−6 | 100 |
| | L1 ratio | 1e−6 | 10 |
| | Fit intercept | True, False | |
| | Normalize | True, False | |
| | Max iterations | 1e3 | 1e6 |
| | Tol | 1e−8 | 1e−2 |
| KRR | Alpha | 1e−6 | 1.0 |
| | Gamma | 1e−4 | 1.0 |
| LGB | Boosting type | gbdt, dart, goss | |
| | No. of leaves | 20 | 100 |
| | No. of estimators | 100 | 1e4 |
| | Learning rate | 1e−6 | 1.0 |
| CBR | Depth | 5 | 10 |
| | Bagging temperature | 1 | 10 |
| | Learning rate | 1e−6 | 1.0 |
| | iterations | 30 | 1e3 |

In step 356, a new population is created by selecting multiple best models with least errors as parents from a previous generation in accordance with one or more embodiments. In some embodiments, a certain elite population may be retained based on an elite percentage for a next generation.

In step 358, an offspring of the new population is created with a crossover probability and a mutation probability in accordance with one or more embodiments. For example, with a crossover probability, the offspring are created. In some embodiments, if no crossover is performed, offspring is an exact copy of the parents. In addition, with a mutation probability, the latest offspring are mutated by slightly changing the hyperparameters of the ML models. The offspring created becomes part of the new population.

In step 360, a determination is made as to whether the current number of generations has reached a predetermined number of generations in accordance with one or more embodiments. In step 362, if the predetermined number of generations is reached, the hyperparameters of the best model are reported and used for generating a base learner model in accordance with one or more embodiments. Else, steps 356 to 360 are repeated until the predetermined number of generations is reached and the hyperparameters of the best model is reported.

Various embodiments of the invention have one or more of the following advantages. Embodiments of the invention reduces the computational effort and improves efficiency in achieving better predictions compared to previous approaches by deploying artificial intelligence/machine learning with some of the automated steps involved in applying machine learning. One or more embodiments of the invention disclosed herein offer the following attractive features: (1) improves the prediction accuracy of the ML algorithm being fast and efficient, specifically for the smaller datasets, (2) selection of a model from a pool of predefined models, model tuning, and model validation process are automated, and (3) facilitates automated hyperparameter optimization to improve prediction accuracy. Additional advantages offered by the invention address the challenge of lack of skilled data scientists and assist domain scientists and engineers in deploying ML to their applications.

Benchmark Datasets

In one or more embodiments, various datasets are used to benchmark GA-based automated ensemble ML model as described in Step 302 in FIG. 3A, and TPOT automated ML model. It is well known that it is very costly to generate large-labeled datasets for most real-world engineering applications. Therefore, to demonstrate the feasibility of the invention to produce good prediction accuracy, the databases with a relatively lower number of data points and a higher number of input features are chosen for a performance comparative study. Table 2 shows the details of the benchmark datasets used in the performance comparative study of the invention, in accordance with one or more embodiments of the invention. The datasets generated for the performance comparison are for illustrative purposes only, and performance of the automated ensemble ML model is not limited to the applications discussed below.

Auto price dataset: In some embodiments, the auto price dataset from the Penn ML Benchmarks (PMLB) database consisting of 159 data records is used for the benchmark. This dataset comprises fourteen input features, out of which thirteen were continuous, and one is a categorical feature and a continuous target.

Boston housing dataset: In some embodiments, Boston housing dataset available in Scikit-Learn, is one of the standard datasets used to benchmark the regression ML models. This dataset comprises 506 data points with thirteen input features and a target. The input features were all real positive numbers, and a target is a real number varying between 5 and 50.

Diabetes dataset: In some embodiments, the diabetes dataset from Scikit-Learn package contains ten input features and a target. The inputs are real numbers between −0.2 and 0.2 and an integer target whose value lies between 25 and 346. There is a total of 442 data records.

Faculty salary dataset: In some embodiments, the faculty salary dataset obtained from the PMLB database consists of 50 data records with four input features and a target. Out of four input features, one is a binary feature, and the rest are continuous features.

US crimes dataset: This dataset contains data related to crimes and demographic statistics for 47 US states in 1960, also obtained from the PMLB dataset. In some embodiments, it comprises thirteen input features, out of which one is a binary feature, and the rest are continuous features with one continuous target feature.

IC engine dataset: In some embodiments, 256 randomly sampled data points from a dataset containing 2048 data records are used as benchmarks. The dataset has nine input features and a target. One of the input features is categorical data, and all other inputs and targets are continuous and real number data.

TABLE 2
Details of the Benchmark Datasets

| Benchmark | No. of | No. of input | No. of categorical |
|---|---|---|---|
| dataset | records | features | features |
| Auto price | 159 | 15 | 1 |
| Boston housing | 506 | 13 | 1 |
| Diabetes | 442 | 10 | 0 |
| Faculty salary | 50 | 4 | 1 |
| US crimes | 47 | 13 | 1 |
| IC engine | 256 | 9 | 1 |

Performance Comparison

In some embodiments, the R² for the six benchmark datasets are computed and plotted using the default ensemble ML model (default SL), the GA-based automated ensemble ML model (AutoSL-GA), the BO-based automated ensemble ML model (AutoSL-BO), and the TPOT automated ML model (TPOT) models. AutoSL-GA consistently outperforms the default SL in prediction accuracy measured by the R². However, in some embodiments, the AutoSL-BO performs poorer than the default SL with the Boston housing, US crimes, and IC engine datasets. This shows that the AutoSL-GA performs better than both the default SL and AutoSL-BO with all six benchmark datasets. Both the AutoSL-BO and the AutoSL-GA perform equally well with the faculty datasets and show only a marginal improvement against the default SL. The stochastic nature of GA helps obtaining better models by optimizing the hyperparameters well in comparison to the sequential model-based optimization algorithm, BO.

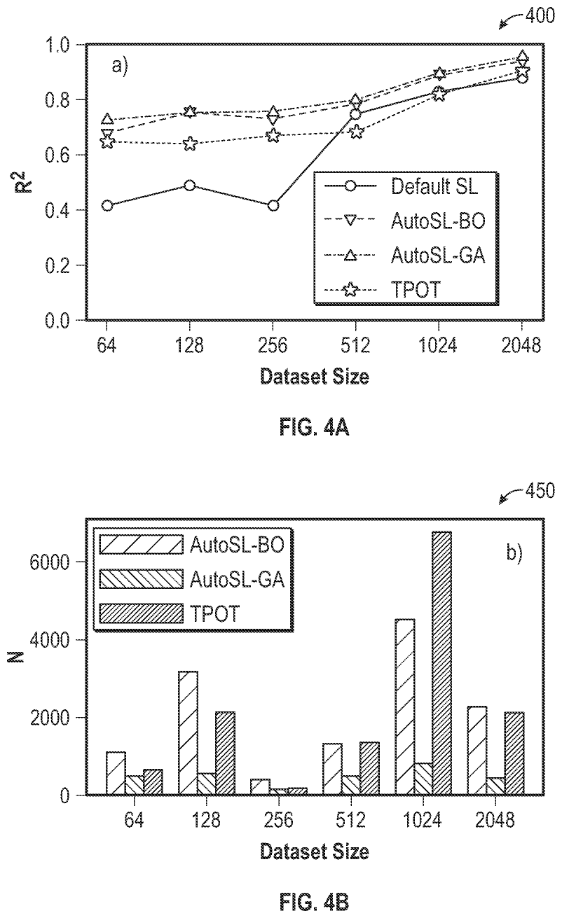

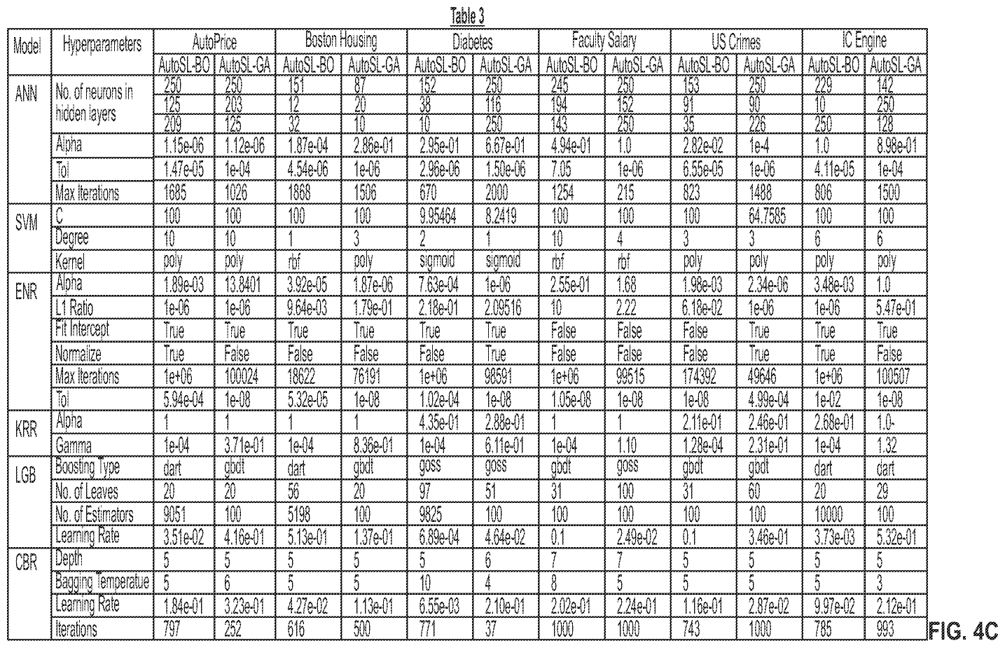

In some embodiments, AutoSL-GA consistently outperforms the TPOT model with all six benchmark datasets. In one or more embodiments, for some datasets like Boston housing, faculty salary, US crimes, and the IC engine, even the default SL performs better than the TPOT. Although the performance of the TPOT highly depends on genetic programming (GP) parameters, the GP parameters are carefully chosen so as not to spend more computational resources. The relatively lower performance of the TPOT could be because of the differences in the models included. For some embodiments, LightGBM and CatBoost models are omitted; however, XGBoost is part of the TPOT compared to the default SL. The optimized hyperparameters of the individual models in the best AutoSL-BO and AutoSL-GA out of ten replicates are shown in Table 3 depicted in FIG. 4C. Table 3 shows that the values of the optimized hyperparameters differ between AutoSL-BO and AutoSL-GA significantly due to the stochastic behavior and fundamental differences in the optimization algorithms.

In one or more embodiments, the other important parameter to evaluate an automated ML model is computational time. Computational times of the models between the AutoSL-BO, the AutoSL-GA, and the TPOT are compared as multiples (N) of computational time of the default SL. The computational times are obtained from a machine with an Intel Xeon E5640 2.67 GHz processor and 56 GB of RAM. All models are run on a single processor for the performance comparison. For all different datasets used in this performance comparison, the AutoSL-GA consumes the least computational times in comparison to the AutoSL-BO and the TPOT. In one or more embodiments, mostly the TPOT consumes lesser time in comparison to the AutoSL-BO except for the Boston housing dataset.

Overall, it can be concluded that the GA-based hyperparameter optimization consumes lesser computational times than the Bayesian-based optimization. Specifically, the AutoSL-GA achieves a tangible improvement in prediction accuracy with the least computational resources compared to the AutoSL-BO and TPOT.

In one or more embodiments, the sensitivity analysis provides an approach to quantify the relationship between model performance and dataset size for the default SL, the AutoSL-GA, the AutoSL-BO, and the TPOT models. It is imperative that every problem is unique. Therefore, the dataset size required for every ML application depends on the complexity of the data, such as the number of input and target features, the relationships between them, the noise in the data, the variance, and the standard deviation of every parameter. The dataset containing 2048 data samples from Moiz et al. (https://doi.org/10.4271/2018-01-0190) is used to analyze sensitivity of each model towards the dataset size. The dataset has been reduced randomly between 64 and 1024 to represent different dataset sizes.

FIGS. 4A and 4B show plots in accordance with one or more embodiments of the invention. FIG. 4A shows a box plot (400) showing sensitivity of the default SL, the AutoSL-GA, the AutoSL-BO, and the TPOT towards the dataset size. In some embodiments, the R² value increases with the dataset size irrespective of the model chosen. However, the AutoSL-GA performs better for any dataset size followed by the AutoSL-BO. Default SL performs poorer for smaller dataset size. However, performance of the default SL may improve with increasing dataset size matching the performance of the TPOT. Although the AutoSL-GA and AutoSL-BO performances are comparable, the AutoSL-GA consumes the least computational resources comparatively, as depicted in a bar plot (450) of FIG. 4B.

In some embodiments, the computational times do not show any trend with the dataset size because of an inherently stochastic nature in choosing the hyperparameters by the optimization schemes. The sensitivity analysis of dataset size shows that the AutoSL-GA outperforms other models in both performance and resources required for any number of data samples for an IC engine application.

Embodiments may be implemented on a computing system. Any combination of mobile, desktop, server, router, switch, embedded device, or other types of hardware may be used. For example, as shown in FIG. 5A, the computing system (500) may include one or more computer processors (502), non-persistent storage (504) (for example, volatile memory, such as random access memory (RAM), cache memory), persistent storage (506) (for example, a hard disk, an optical drive such as a compact disk (CD) drive or digital versatile disk (DVD) drive, a flash memory), a communication interface (512) (for example, Bluetooth interface, infrared interface, network interface, optical interface), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, or electronic pen.

The communication interface (512) may include an integrated circuit for connecting the computing system (500) to a network (not shown) (for example, a local area network (LAN), a wide area network (WAN), such as the Internet, mobile network, or any other type of network) or to another device, such as another computing device.

Further, the computing system (500) may include one or more output devices (508), such as a screen (for example, a liquid crystal display (LCD), a plasma display, touchscreen, cathode ray tube (CRT) monitor, or projector), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s) is configured to perform one or more embodiments of the disclosure.

The computing system (500) in FIG. 5A may be connected to or be a part of a network. For example, as shown in FIG. 5B, the network (520) may include multiple nodes (for example, node X (522), node Y (524)). Each node may correspond to a computing system, such as the computing system shown in FIG. 5A, or a group of nodes combined may correspond to the computing system shown in FIG. 5A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory or resources.

The nodes (for example, node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include or perform all or a portion of one or more embodiments of the disclosure.

The computing system or group of computing systems described in FIGS. 5A and 5B may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided in subsequent paragraphs.

Based on the client-server networking model, sockets may serve as interfaces or communication channel end-points enabling bidirectional data transfer between processes on the same device. Foremost, following the client-server networking model, a server process (for example, a process that provides data) may create a first socket object. Next, the server process binds the first socket object, thereby associating the first socket object with a unique name or address. After creating and binding the first socket object, the server process then waits and listens for incoming connection requests from one or more client processes (for example, processes that seek data). At this point, when a client process wishes to obtain data from a server process, the client process starts by creating a second socket object. The client process then proceeds to generate a connection request that includes at least the second socket object and the unique name or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (for example, bytes).

Shared memory refers to the allocation of virtual memory space in order to substantiate a mechanism for which data may be communicated or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

The computing system of FIG. 5A may include functionality to present raw or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, for example, data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, for example, by obtaining data from a data attribute within the data object that identifies the data object type. Then, the GUI may determine any rules designated for displaying that data object type, for example, rules specified by a software framework for a data object class or according to any local parameters defined by the GUI for presenting that data object type. Finally, the GUI may obtain data values from the particular data object and render a visual representation of the data values within a display device according to the designated rules for that data object type.

The previous description of functions presents only a few examples of functions performed by the computing system of FIG. 5A and the nodes or client device in FIG. 5B. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed. Accordingly, the scope of the disclosure should be limited only by the attached claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for a hyperparameter optimization for an automated ensemble machine learning model, comprising:
generating, using a computer processor, an initial population of a plurality of machine learning (ML) models with a plurality of randomly chosen hyperparameters;
calculating, using the computer processor, a loss function for each of the plurality of machine learning models;
creating, using the computer processor, a new population of ML models, comprising the steps of:
(a) selecting multiple best models with least errors as parents from a previous generation;
(b) creating an offspring of the new population of ML models with a crossover probability and a mutation probability; and
(c) repeating the steps (a) and (b) until a number of generations is reached and reporting the hyperparameters of the best model; and
generating, using the computer processor, a base learner model using the hyperparameters of the best model.

2. The method of claim 1, further comprising retaining an elite population of ML models based on an elite percentage for a next generation.

3. The method of claim 1, wherein the hyperparameters consisting of continuous parameters, categorical parameters, and constant parameters.

4. The method of claim 1, wherein if no crossover probability is performed, the offspring is an exact copy of the parents.

5. The method of claim 1, wherein the offspring is mutated with the mutation probability by slightly changing the hyperparameters.

6. The method of claim 3, wherein the continuous parameters are the hyperparameters whose values are continuous real or integer numbers, and the categorical parameters are the hyperparameters whose values are categorical.

7. The method of claim 3, wherein the constant parameters are the hyperparameters whose values are other than default values for the machine learning models and need to be kept constant.

8. A method for an automated ensemble machine learning model, comprising the steps of:
obtaining a raw dataset and performing feature engineering, using a computer processor, to extract features and targets to obtain a processed dataset using a domain knowledge;
dividing, using the computer processor, the processed dataset into training, test, and validation datasets;
training, using the computer processor, a plurality of default or optimized base learner models, using the training datasets to produce a plurality of trained base learner models;
calculating, using the computer processor, predictions of the plurality of the trained base learner models using the test datasets;
calculating, using the computer processor, an optimal weighted model from the plurality of trained base learner models to build a trained automated ensemble machine learning (ML) model using a constrained-based optimization algorithm based on a prediction accuracy of an automated ensemble ML model, if the trained base learner models are not tuned using a hyperparameter optimization; and
validating, using the computer processor, the trained automated ensemble ML model using the validation datasets, previously set aside exclusively for validation purposes,
wherein the hyper parameter optimization comprising the steps of:
generating, using the computer processor, an initial population of a plurality of (ML models with a plurality of randomly chosen hyperparameters;
calculating, using the computer processor, a loss function for each of the machine learning models;
creating, using the computer processor, a new population of ML models, comprising the steps of:
(a) selecting multiple best models with least errors as parents from a previous generation;
(b) creating an offspring of the new population with a crossover probability and a mutation probability; and
(c) repeating the steps (a) and (b) until a number of generations is reached and reporting the hyperparameters of the best model; and
generating, using the computer processor, the base learner model using the hyperparameters of the best model;
repeating the steps of the method, using the computer processor, until a satisfactory automated ensemble ML model is obtained.

9. The method of claim 8, further comprising retaining an elite population based on an elite percentage for a next generation.

10. The method of claim 8, wherein the hyperparameters consisting of continuous parameters, categorical parameters, and constant parameters.

11. The method of claim 8, wherein if no crossover probability is performed, the offspring is an exact copy of the parents.

12. The method of claim 8, wherein the offspring is mutated with the mutation probability by slightly changing the hyperparameters.

13. The method of claim 10, wherein the continuous parameters are the hyperparameters whose values are continuous real or integer numbers and the categorical parameters are the hyperparameters whose values are categorical.

14. The method of claim 10, wherein the constant parameters are the hyperparameters whose values are other than default values for the machine learning models and need to be kept constant.

15. A non-transitory computer readable medium storing instructions executable by a computer processor, the instructions comprising functionality for:
generating an initial population of a plurality of machine learning (ML) models with a plurality of randomly chosen hyperparameters;
calculating a loss function for each of the machine learning models;
creating a new population, comprising the steps of:
(a) selecting multiple best models with least errors as parents from a previous generation;
(b) creating an offspring of the new population of ML models with a crossover probability and a mutation probability; and
(d) repeating the steps (a) and (b) until a number of generations is reached and reporting the hyperparameters of the best model; and
generating a base learner model using the hyperparameters of the best model.

16. The non-transitory computer readable medium of claim 15, wherein the instructions further comprise functionality for retaining an elite population of ML models based on an elite percentage for a next generation.

17. The non-transitory computer readable medium of claim 15, wherein the hyperparameters consisting of continuous parameters, categorical parameters, and constant parameters.

18. The non-transitory computer readable medium of claim 15, wherein if no crossover probability is performed, the offspring is an exact copy of the parents.

19. The non-transitory computer readable medium of claim 15, wherein the offspring is mutated with the mutation probability by slightly changing the hyperparameters.

20. The non-transitory computer readable medium of claim 17, wherein the continuous parameters are the hyperparameters whose values are continuous real or integer numbers, the categorical parameters are the hyperparameters whose values are categorical, and the constant parameters are the hyperparameters whose values are other than default values for the machine learning models and need to be kept constant.
